(19) United States
(12) Patent Application Publication
(10) Pub. No.: US 2017/0328266 A1
(43) Pub. Date: Nov. 16, 2017

(54) Internal Combustion Engine, Pre-Chamber Insert, And Fuel Injector

(71) Applicant: MAN Diesel & Turbo SE, Augsburg (DE)

(72) Inventor: Johannes BÄR, Schwabach (DE)

(21) Appl. No.: 15/519,922

(22) PCT Filed: Sep. 30, 2015
(86) PCT No.: PCT/EP2015/072637

§ 371 Date: Apr. 18, 2017

(30) Foreign Application Priority Data
Oct. 30, 2014 (DE) 102014016127.7

(51) Int. Cl. F02B 19/10; F02M 57/06; F02M 21/02; F02M 61/14; F02B 19/12

(52) U.S. Cl. CPC F02B 19/108; F02M 61/14; F02B 19/12; F02M 21/0275; F02M 57/06

(57) ABSTRACT

An internal combustion engine, includes at least one cylinder, wherein the or each cylinder includes a main combustion chamber for burning fuel in the cylinder, wherein an assembly serving to supply and/or ignite fuel is installed on a cylinder head of each cylinder between gas exhaust valves of the cylinder in such a way that the assembly is inserted into a cut-out in the cylinder head of the cylinder and is sealed to said cut-out, wherein a segment of the assembly that is inserted into the cut-out in the cylinder head of the cylinder has an oval contour in the cross-section, and wherein a bounding surface of said segment of the assembly, which bounding surface lies in the sealing region, is contoured in such a way that said bounding surface is continuously convexly curved outward in the peripheral direction.

### PRIORITY CLAIM

This is a U.S. national stage of application No. PCT/EP2015//07263, filed on Sep. 30, 2015. Priority is claimed on the following application: Country: Germany, Application No.: 10 2014 016 127.7, filed: Oct. 30, 2014, the content of which is/are incorporated herein in its entirety by reference.

### FIELD OF THE INVENTION

The present invention relates to an internal combustion engine such as a gas engine, a prechamber insert for such gas engine and to a fuel injector for a diesel engine.

### BACKGROUND OF THE INVENTION

From US2013/232990A1, the entire content of which is incorporated herein by reference an internal combustion engine designed as gas engine having at least one cylinder is known. The respective cylinder of the gas engine comprises a main combustion chamber and a prechamber, wherein the prechamber is provided by a prechamber insert. The prechamber insert is also described as prechamber retainer. According to US2013/232990A1, the prechamber provides the insert and furthermore accommodates assemblies that are relevant to the gas supply and the gas ignition. The assemblies serving for the gas supply include a non-return valve, the assemblies relevant to the gas ignition include a spark plug. The prechamber insert according to US2013/232990A1 is mounted on a cylinder head of the respective cylinder between gas exchange valves of the respective cylinder, wherein the prechamber insert is inserted into a cut-out in the cylinder head of the respective cylinder and sealed relative to the cylinder head. In known gas engines, the prechamber insert has a cylindrical shape and accordingly a contour that is circular in cross section.

In particular when the installation space that is available between the gas exchange valves is limited, the arrangement of the prechamber insert on the cylinder head causes difficulties. In particular it is not possible then to arrange the non-return valve at a minimum distance from the prechamber so that the non-return valve then has to be positioned at a greater distance from the prechamber, as a result of which a relatively long gas-conducting bore between non-return valve and prechamber becomes necessary. Because of this, vibrations can form in the gas column of this bore which render accurate metering of gas into the prechamber difficult or impossible.

Similar problems also exist with other internal combustion engines, in particular with diesel engines, in the case of which assemblies serving for the fuel supply and/or the fuel ignition, in particular fuel injectors, have to be mounted on the cylinder head of the cylinders.

It is thus an object of the present invention is to provide a new type of internal combustion engine such as a gas engine, a new type of prechamber insert for a gas engine and a new type of fuel injector for a diesel engine.

### SUMMARY OF THE INVENTION

According to the invention, a section of the respective assembly that is inserted in the cut-out in the cylinder head of the respective cylinder, which serves for the fuel supply and/or the fuel ignition, is contoured oval in cross section, wherein a boundary surface of this section of the respective assembly located in the sealing region is contoured continuously convexly curved outward in the peripheral direction.

With the present invention it is proposed for the first time to contour an assembly serving for the fuel supply and/or the fuel ignition on the section, via which the same is inserted into the cut-out in the cylinder head, no longer circular in cross section but rather oval according to the invention. Because of this it is possible to better utilise the installation space that is available on the cylinder head. Because of the fact that in the sealing region of the assembly serving for the fuel supply and/or the fuel ignition the boundary surface, which is contoured oval in cross section, is contoured continuously convexly curved outward in the peripheral direction, an unrestricted sealing of the assembly relative to the cylinder head can be realised.

In the case of an assembly designed as prechamber insert serving for the fuel supply and the fuel ignition it is possible to position the non-return valve at a minimal distance from the prechamber so that a fuel-conducting line running between the non-return valve and the prechamber can be embodied with minimal length and accordingly minimum volume. Because of this it is possible to accomplish the fuel metering more accurately.

According to an advantageous further development, the respective assembly serving for the fuel supply and/or the fuel ignition carries axially offset seals on the boundary surface located in the sealing region, namely a lower seal facing the main combustion chamber and an upper seal facing away from the main combustion chamber. The seal allows good sealing of the assembly serving for the fuel supply and/or the fuel ignition in the cylinder head.

In particular when the internal combustion engine is designed as gas engine and the respective assembly as prechamber insert a non-return valve of the prechamber insert serving for the gas conduct is received laterally next to a spark plug of the prechamber insert serving for the gas ignition above a prechamber of the prechamber insert in the prechamber insert in such a manner that the non-return valve is positioned below the lower seal. According to a further advantageous further development, a gas supply bore serving for the gas conduct, via which the gas can be conducted in the direction of the prechamber of the respective prechamber insert, then opens at the boundary surface in the sealing region between the lower seal and the upper seal. Optimal sealing of the prechamber insert relative to the cylinder head and an optimal utilisation of the installation space that is available on the cylinder head is therefore ensured.

### BRIEF DESCRIPTION OF THE DRAWINGS

Exemplary embodiments of the invention are explained in more detail by way of the drawing in which:

FIG. 1: is a cross sectional view through a cylinder of an internal combustion engine designed as gas engine in the region of a prechamber insert of the cylinder;

FIG. 2: is a top view of a prechamber insert of the gas engine of FIG. 1 according to the invention; and

FIG. 3: is a perspective view of the prechamber insert.

### DETAILED DESCRIPTION OF THE PRESENTLY PREFERRED EMBODIMENTS

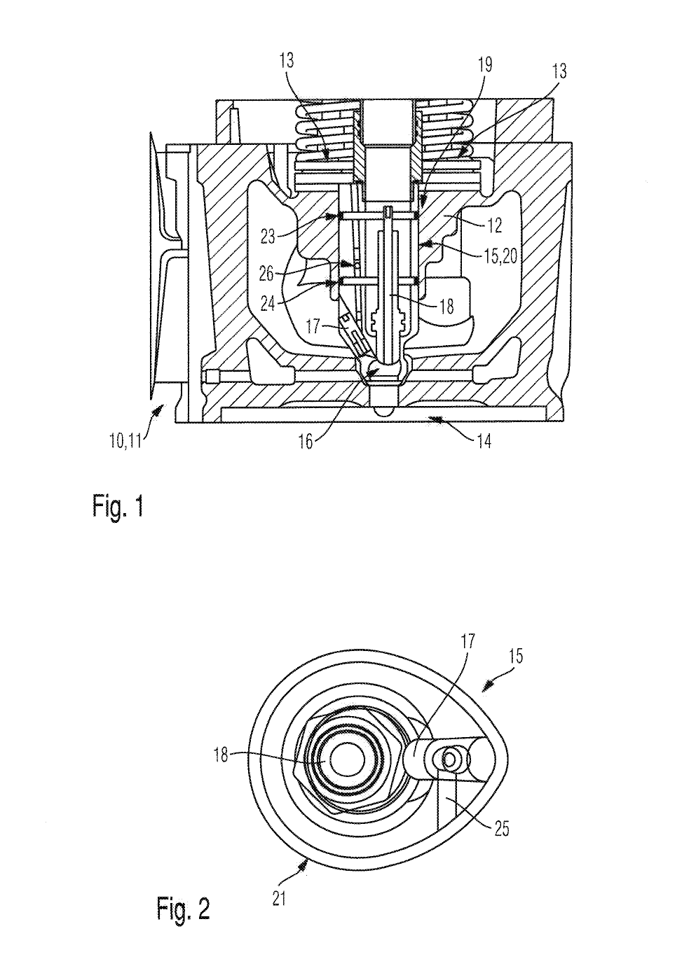

The present invention relates, inter alia, to an internal combustion engine preferentially designed as gas engine and to a prechamber insert for a gas engine. The invention can also be utilised with other internal combustion engines such as diesel engines in particular in the region of fuel injectors of the diesel engines. The invention is described making reference to FIGS. 1 to 3 for the preferred application of a gas engine and of a prechamber insert for a gas engine.

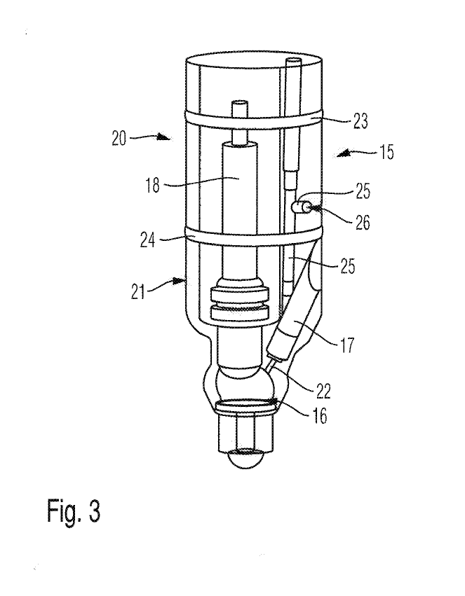

FIG. 1 shows a cross section through a gas engine 10 in the region of a cylinder 11 of the gas engine 10, wherein of the cylinder 11 a cylinder head 12 is shown. In the region of the cylinder head 12, gas exchange valves 13 are formed which, starting out from a camshaft, can be opened and closed. At the bottom, the cylinder head 12 delimits a main combustion chamber 14 of the respective cylinder 11 at least in sections. The cylinder 11 of the gas engine 10 is assigned a prechamber 15 which forms a prechamber 16 for the cylinder 11 and furthermore carries assemblies that are relevant to the gas conduct and to the gas ignition. In FIGS. 2 and 3 the prechamber insert 15 is shown on its own in each case. The assemblies of the prechamber insert 15 that are relevant to the gas conduct include a non-return valve 17, wherein the assemblies of the prechamber insert 15 that are relevant to the gas ignition include a spark plug 18.

The prechamber insert 15 is mounted on the cylinder head 12 of the cylinder 11 of the gas engine 10 in such a manner that the prechamber insert 15 is inserted into a cut-out 19 in the cylinder head 12 of the respective cylinder 11 and sealed relative to the cylinder head 12, wherein the prechamber insert 15 is accommodated on the cylinder head 12 in the region between the gas exchange valves 13 of the respective cylinder 11 of the gas engine 10.

In terms of the invention, a section 20 of the prechamber insert 15 inserted into the cut-out 19 of the cylinder head 12 is contoured oval in cross section, wherein the boundary surface 21 of this section 20 of the prechamber insert 15 located in the sealing region between prechamber insert 15 and cylinder head 12 is contoured continuously convexly curved outward in the peripheral direction (see in particular FIG. 2).

Through the oval contouring of the section 20 of the prechamber insert 15 projecting into the cut-out 19 of the cylinder head 12, the installation space that is available on the cylinder head 12 can be optimally utilised, in particular, the non-return valve 17 of the prechamber insert 15 can be positioned at a lesser distance from the prechamber 16 of the prechamber insert 15 so that a bore 22 of the prechamber insert 15 serving for the gas conduct extending between the non-return valve 17 and the prechamber 16 can be embodied with minimal length and accordingly minimal volume. Because of this it is possible to introduce the gas into the prechamber 16 of the prechamber insert 15 with great accuracy.

As can be seen in particular from FIG. 3, the prechamber insert 15 carries axially offset seals 23 and 24 on the boundary surface 21 located in the sealing region between the prechamber insert 15 and the cylinder head 12, namely a lower seal 24 facing the main combustion chamber 14 and an upper seal 23 facing away from the main combustion chamber 14. An optimal sealing of the prechamber insert 15 in the cut-out 19 of the cylinder head 12 is thereby possible.

These seals 23 and 24 are preferentially O-ring seals or alternatively moulded seals.

The non-return valve 17 of the prechamber insert 15 serving for the gas conduct is received, according to FIG. 3, in the prechamber insert 15 laterally next to the spark plug 18 of the prechamber insert 15, which serves for the gas ignition, and above the prechamber 16 of the prechamber insert 15, namely below the lower seal 24.

A gas supply bore 25 serving for the gas contact opens with a cut-out or opening 26 at the boundary surface 21 of the prechamber insert 15 located in the sealing region between the two seals 23 and 24.

On diesel engines, fuel injectors can be configured analogously.

Such a fuel injector is mountable to a cylinder head of a cylinder of the diesel engine in such a manner that the fuel injector, in particular an injector sleeve of the same, can be inserted into a cut-out of the cylinder head of the cylinder and is sealed relative to the same. Here, a section of the fuel injector that can be inserted into the cut-out in the cylinder head of the cylinder, in particular of the injector sleeve, is then contoured oval in cross section, wherein a boundary surface of this section of the fuel injector, in particular of the injector sleeve, located in the sealing region, is contoured continuously convexly curved outward in the peripheral direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An internal combustion engine (10) comprising:
at least one cylinder (11) including a main combustion chamber (14) for burning fuel in the cylinder;
a cylinder head (12) having a cut-out (19) and gas exchange valves (13);
an assembly (15) for fuel supply and/or fuel ignition having a section (20) inserted and sealed in a sealing region in the cut-out (19) of the cylinder head (12) between the gas exchange valves (13);
wherein the section (20) of the assembly (15) has a boundary surface (21) and is contoured oval in cross-section; and
wherein the boundary surface (21) of this section (20) of the assembly (15) located in the sealing region is contoured continuously convexly curved in the peripheral direction.

12. The internal combustion engine according to claim 11, wherein the prechamber insert (15) carries axially offset seals (23, 24) on the boundary surface (21) located in the sealing region, the seals comprising a lower seal (24) facing the main combustion chamber (14) and an upper seal (23) facing away from the main combustion chamber (14).

13. The internal combustion engine according to claim 12, wherein the seals (23, 24) are designed as O-ring seals.

14. The internal combustion engine according to claim 12, wherein the internal combustion engine (10) is designed as gas engine and the assembly (15) is designated as a prechamber insert, the prechamber insert comprising a non-return valve (17) for conducting gas and a spark plug for gas ignition, and wherein the non-return valve (17) is received laterally next to the spark plug (18) above the prechamber (16) in the prechamber insert (15) so that the non-return valve (17) is positioned below the lower seal (24).

15. The internal combustion engine according to claim 14, additionally comprising a gas supply bore (25) for conducting gas in the direction of the prechamber (16), the gas supply bore (25) opening at the boundary surface (21) in the sealing region between the lower seal (24) and the upper seal (23).

16. The internal combustion engine according to claim 12, wherein internal combustion engine (10) is designed as diesel engine and the assembly (15) as a fuel injector.

17. A prechamber insert (15) for a gas engine comprising:
a prechamber (16) and assemblies for gas supply and gas ignition;
the prechamber insert (15) being mountable on a cylinder head (12) of a cylinder (11) of the gas engine between gas exchange valves (13) of the cylinder (11) having a section (20) including a boundary surface (21) so that the prechamber insert (15) can be sealingly inserted in a sealing region into a cut-out (19) in the cylinder head (12);
wherein the section (20) of the prechamber insert (15) that can be inserted into the cut-out (19) in the cylinder head (12) is contoured oval in cross-section; and
wherein the boundary surface (21) of the section (20) of the prechamber insert (15) located in the sealing region is contoured continuously convexly curved in the peripheral direction.

18. The prechamber insert according to claim 16, additionally comprising axially offset seals on the boundary surface (21) located in the sealing region, the seals comprising a lower seal (24) and an upper seal (23); and
a spark plug (18) and a non-return valve (17); non-return valve being disposed laterally next to the spark plug (18) disposed above the prechamber (16) in the prechamber insert (15) such that the the non-return valve (17) is positioned below the lower seal (24) for minimising the distance between non-return valve (17) and the prechamber (16).

19. The prechamber insert according to claim 17, additionally comprising a gas supply bore (25) for conducting gas in the direction of the prechamber (16) of the prechamber insert (15), the gas supply bore (25) opening at the boundary surface (21) in the sealing region between the lower seal (24) and the upper seal (23).

20. A fuel injector for a diesel engine, wherein the fuel injector can be mounted on a cylinder head of a cylinder of the diesel engine in such a manner that a section of the fuel injector can be inserted into a cut-out in the cylinder head of the cylinder, wherein the section of the fuel injector that can be sealingly inserted into the cut-out in a sealing region in the cylinder head of the cylinder is contoured oval in cross section, and wherein a boundary surface of the section of the fuel injector located in the sealing region is contoured continuously convexly curved outward in the peripheral direction.

21. The internal combustion engine according to claim 13, wherein the internal combustion engine (10) is designed as gas engine and the assembly (15) is designated as a prechamber insert, the prechamber insert comprising a non-return valve (17) for conducting gas and a spark plug for gas ignition, and wherein the non-return valve (17) is received laterally next to the spark plug (18) above the prechamber (16) in the prechamber insert (15) so that the non-return valve (17) is positioned below the lower seal (24).

22. The prechamber insert according to claim 18, additionally comprising a gas supply bore (25) for conducting gas in the direction of the prechamber (16) of the prechamber insert (15), the gas supply bore (25) opening at the boundary surface (21) in the sealing region between the lower seal (24) and the upper seal (23).
